(19) United States
(12) Patent Application Publication
(10) Pub. No.: US 2012/0150326 A1
(43) Pub. Date: Jun. 14, 2012

(54) METHOD FOR REFRESHING A RUNNING TIME FOR A SPORTS COMPETITION IN PROGRESS

(75) Inventor: Fabien BLONDEAU, Chezard-St-Martin (CH)

(73) Assignee: Swiss Timing Ltd, Corgemont (CH)

(21) Appl. No.: 13/292,608

(22) Filed: Nov. 9, 2011

(30) Foreign Application Priority Data
Nov. 12, 2010 (EP) 10191109.7

(51) Int. Cl. G06F 19/00

(52) U.S. Cl. 700/91

(57) ABSTRACT

A method for refreshing of a running time for a sports competition in progress in a receiver device, on the basis of data signals. Data signals are transmitted from a transmitter as the sports competition is taking place. These data signals include data about the starting time of a competitor, one or several intermediate times and a final finish time. A receiver receives the data signals in succession. The receiver is thus provided for refreshing the running time of the sports competition after a determined temporal lag in the receiver, and following the indication of a starting time in the received data signals. The running time is then stopped in the receiver, once the time counted in the receiver matches the final time in the received data signals.

This application claims priority from European Patent Application No. 10191109.7 filed Nov. 12, 2010, the entire disclosure of which is incorporated herein by reference.

### FIELD OF THE INVENTION

The invention concerns a method for refreshing at least one running time for a sports competition in progress, in a receiver device.

The invention also concerns an apparatus for transmitting data to implement a method for refreshing a running time for a sports competition in progress.

### BACKGROUND OF THE INVENTION

The sports competition may be a race that is continuously judged for successive competitors, or competitors who start at the same time from a starting point, in an outdoor or indoor location. The sports competition may, for example, be a ski race, a motor race, an athletics race, a swimming race, a rowing race or any other type of competition where the competitors' time has to be measured. The sports competition may also be a sports match between two teams for which an initial time, several intermediate stop times, a final time and a score between the two teams, can be communicated to a receiver device. The sports competition may, for example be a basketball, ice hockey, or water polo match, or various other sports matches having a determined period of play.

The running time during a sports competition is the time measured by the timing circuit of a transmitter device during the race of one or more competitors. The running time starts after reception of a race start signal and ends for each competitor upon reception of the finish signal. The running time from the start of at least one competitor is generally displayed on a large display screen arranged at the finish line for the spectators of said sports competition. The starting time, one or several intermediate times and a final finish time for each competitor may also be displayed on said large screen.

The transmitter device, which includes the timing circuit for the sports competition, may also communicate all of the race data to one or several receiver devices. These receiver devices may be arranged at the sports competition venue or also at a distance from the place where the sports competition is in progress. For receiver devices that are remote from the venue or at the sports competition venue, some required data connected to the sports competition may be communicated by the transmitter device via a communication network, such as the Internet or UMTS (GSM), to one or several receiver devices. The transmission of data signals from the transmitter device to at least one receiver device remote from the sports competition venue is generally of variable duration. The variable transmission time depends upon many data signal communication conditions and, in particular, the data transmission load via the communication network, such as the Internet.

A variable transmission time for supplying data signals for a race from a transmitter device to at least one receiver device may cause some problems. It may be difficult to ensure that a sports competition running time is regularly refreshed in a receiver device without any jerkiness, to enable it to follow live the developments in a sports competition that is in progress. This constitutes a drawback of state of the art data transmission apparatus for sports competitions, for refreshing, for example, a running time in a remote receiver device.

### SUMMARY OF THE INVENTION

It is thus an object of the invention to overcome the drawbacks of the state of the art by proposing a method for refreshing at least one running time for a sports competition in progress, in a receiver device, which is simple to operate in the receiver device, without using excessive electric power and which allows a running time to be continuously refreshed without any jerkiness.

The invention therefore concerns a method for refreshing at least one running time for a sports competition in progress in at least one receiver device on the basis of data signals transmitted by a transmitter device, wherein said method includes the steps of:
transmitting data signals from the transmitter device as the sports competition is taking place,
receiving data signals in at least one receiver device, and
in the receiver device, refreshing the running time of the sports competition in progress after a determined temporal lag in said receiver device, following the indication of a starting time in the received data signals, and
stopping the running time in the receiver device, once the time counted in the receiver device matches the final time in the received data signals.

Particular steps of the method for refreshing the running time are defined in the dependent claims 2 to 9.

One advantage of the method for refreshing a running time in a receiver device lies in the fact that a temporal lag is set in the device so as to start the running time after a determined temporal interval and following the indication of a starting time in the received data signals. Under these conditions, the running time is not dependent on a variable data signal transmission time between the transmitter device and the receiver device. Thus, no particular interference occurs when the running time is refreshed in the receiver device and the time can be continuously displayed on a display screen without any jerkiness. The starting time, the intermediate times and the final finish time may also be displayed directly and accurately without any correction of the displayed time being performed thereafter. A running time is refreshed with a small temporal interval between the running time of the sports competition venue and the time refreshed in the receiver device to provide substantially live presentation of the progress of said sports competition.

Advantageously, the time base of the receiver device, which may be automatically and regularly reset, does not need to be accurate to a hundredth of a second like the timing circuit of a sports competition in progress. The receiver device time base is sufficiently accurate to refresh the running time to a tenth of a second.

Advantageously, few messages, i.e. few data signals, need to be picked up by the receiver device to refresh a running time without any jerkiness. The receiver device only needs to receive a starting time, one or several intermediate times and a finish time to refresh the running time of the sports competition continuously and without any jerkiness. A reduction is therefore obtained in the electric power consumption of the receiver device for refreshing a running time.

The invention therefore also concerns a data transmission apparatus for implementing the method for refreshing at least one running time for a sports competition in progress in at least one receiver device according to wherein the apparatus includes a transmitter device, which contains a timing circuit for measuring the time of a sports competition, the transmitter device transmitting data signals relating to the starting time of the sports competition and data signals relating to the final time of the sports competition, and at least one receiver device for receiving the data signals from the transmitter device so as to refresh at least one time of the sports competition in progress after a determined temporal lag in the receiver device so as to refresh the running time continuously and without any jerkiness.

Specific embodiments of the data transmission apparatus are defined in the dependent claims 11 to 15.

### BRIEF DESCRIPTION OF THE INVENTION

The objects, advantages and features of the method for refreshing a running time of a sports competition in progress in a receiver device, and an apparatus for implementing the same will appear more clearly in the following description of at least one non-limiting embodiment, illustrated by the drawings, in which:

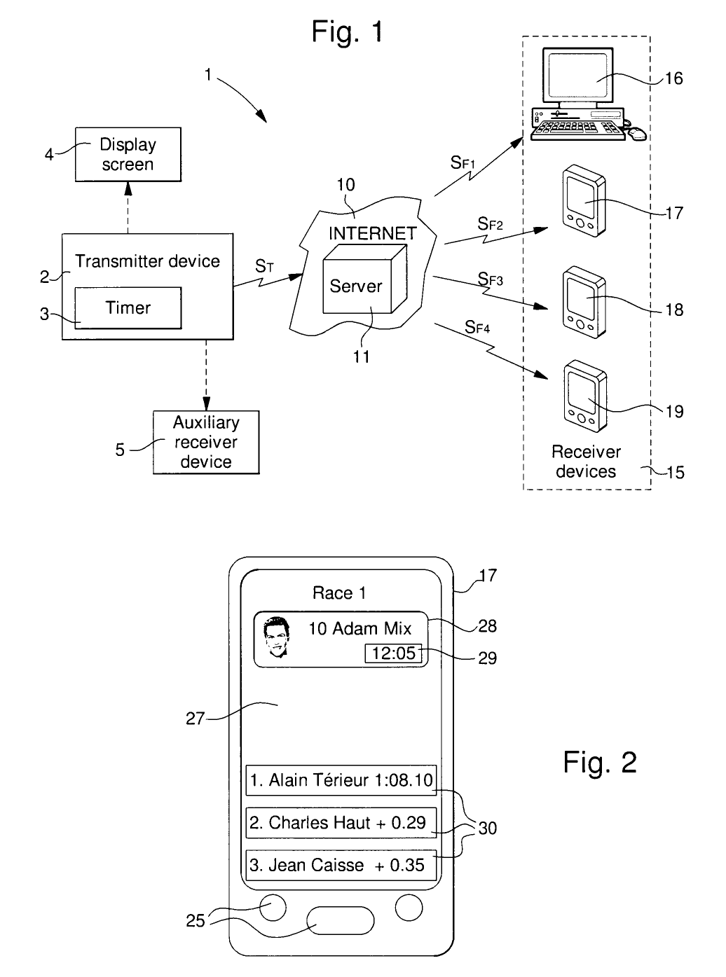

FIG. 1 shows a schematic view of a data transmission apparatus for implementing the running time refreshing method for a sports competition in progress according to the invention,

FIG. 2 shows a simplified view of a receiver device, in the form of a mobile telephone, for refreshing a running time for a sports competition in progress according to the invention,

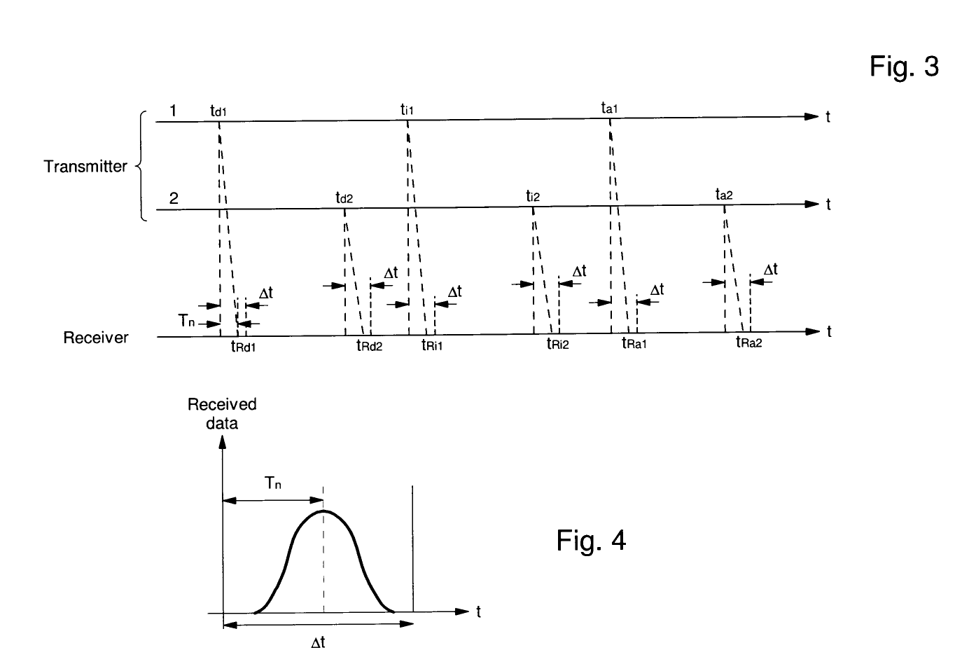

FIG. 3 shows a temporal graph of the temporal data signals, transmitted by a transmitter device, relating to two successive competitors and received by a receiver device according to the invention, and

FIG. 4 shows a graph of the measured transmission time variation in messages transmitted by a transmitter device and received by a remote receiver device.

### DETAILED DESCRIPTION OF THE INVENTION

In the following description, all those elements of the data transmission apparatus for implementing a method for refreshing at least one running time in a receiver device, which are well known to those skilled in the art in this technical field, will be described only in a simplified manner.

FIG. 1 shows a schematic view of a data transmission apparatus 1, which is used for implementing the method for refreshing a sports competition running time in at least one receiver device 5, 15.

Apparatus 1 includes, first of all, a transmitter device 2, which may be arranged at the sports competition venue. This transmitter device at the sports competition venue includes at least one timing circuit 3, accurate to at least a hundredth or a thousandth of a second, for measuring the competitors' time in a sports competition. In a well known manner, the sports competition time may be measured in succession or in superposition when a first running time of a first competitor and a second running time of a second competitor, who started after the first competitor, are shown. Timing circuit 3 may manage several running times at the same time, for one or several competitors. After every starting time indicated to timing circuit 3 to start every running time, timing circuit 3 is able to take each desired intermediate time and at least one final finish time for one or more competitors. The information for each running time of timing circuit 3 can be displayed on a large display screen 4 by a suitable connection between the timing circuit and the large display screen.

Apparatus 1 may also include at least one auxiliary receiver device 5, which is connected by a cable to transmitter device 2, for example, at the sports competition venue, and one or several receiver devices 15, 16, 17, 18, 19, which are remote from the venue or at the venue of the sports competition in progress. These receiver devices 15 are, for example, at least one computer terminal 16 and one or several portable devices, such as mobile telephones 17, 18 and 19. The communication of data signals S_{T} from transmitter device 2 may occur via a communication network 10, such as the Internet. A server 11 may be used for storing data and the simultaneous transmission of various data signals S_{F1}, S_{F2}, S_{F3}, S_{F4}, to various remote receiver devices 16, 17, 18 and 19. These data signals S_{F1}, S_{F2}, S_{F3}, S_{F4}, correspond to data signals S_{T} directly transmitted from transmitter device 2. The communication network may also be the UMTS (GSM) network.

The receiver device(s) 5, 15 may be capable of refreshing the running time with a slight temporal lag so as to eliminate any interference during transmission of data signals S_{T} from transmitter device 2. In order to do this, the receiver device 5, 16, 17, 18, 19 starts the count of at least one running time for at least one competitor who is racing after a determined temporal interval Δt and following reception of a starting time supplied by transmitter device 2. Owing to this temporal lag which is set in receiver device 5, no interference or jerkiness occurs during the continuous refreshment of the running time and the display thereof on a display screen of said receiver device 5, 15. The running time, regularly refreshed in receiver device 5, 15, is then stopped once the time counted in the receiver device matches the final time in the previously received data signals. One or several intermediate times may be indicated in the receiver device once the counted time of the refreshed running time matches the intermediate times in the received data signals.

The determined temporal lag Δt may be set directly in receiver device 5, 15 by the user of the receiver device. This temporal lag may be roughly estimated to take account, for example, of a variable transmission time Tn as shown in the graph in FIG. 4. It may be set for example at 3 seconds. This determined temporal lag Δt may be greater than any estimated transmission time Tn. Consequently, the user can see on the receiver device the running time for at least one competitor, who is racing, and possibly any intermediate time, practically live and without any jerkiness.

Since receiver device 5, 15 includes a time base, which does not need to be as accurate as the time measured by timing circuit 3, it may also display the time in addition to the refreshed time with a determined temporal lag. This time may be the same as the time of the sports competition venue or it may be different. Under these conditions, a temporal offset must be taken into account in the receiver device, but this does not adversely affect the refreshing of the running time.

The data signals S_{T} transmitted by transmitter device 2 include, in succession, in particular, the information relating to the starting time of every competitor or to the starting time of a sports match, to one or several intermediate times and to a finish time. In a well known manner, the time of the sports competition venue, the number and type of sports competition, such as a race, the identification of each competitor with his or her number, or team, and the indication of the type of time transmitted are also comprised in the data signals transmitted by transmitter device 2. This information may be displayed on a display screen of the receiver device at the same time as at least one running time for a competitor who is racing, together with the start, intermediate and finish times.

In order to determine the transmission time Tn of the data signals between transmitter device 2 and at least one receiver device 5, 15, such as a computer terminal 16 or a mobile telephone 17, 18, 19, various preliminary data signals must first be exchanged in an initialisation phase. A transmission time calculation may thus be carried out in the receiver device in order to estimate the transmission time Tn as shown in FIG. 4. Following the determination of the transmission time, the receiver device may be configured to set a sufficient temporal lag Δt in order to start refreshing a running time in the receiver device after reception of the starting signal. This temporal lag Δt may also be set without directly taking account of the transmission time calculation. The temporal lag may be set with a pre-set value.

A receiver device 5, 15 may also be capable of refreshing a first running time of the sports competition in progress, for a first competitor, and a second running time for a second competitor, who started after the first competitor. The first running time starts after a determined temporal lag Δt and following the indication of a first starting time of the first competitor in the received data signals S_{T}. The second running time starts after a determined temporal lag Δt and following the indication of a second starting time of the second competitor in the received data signals S_{T}. This second running time starts before or after reception by receiver device 5, 15 of a first final time for the first competitor in the received data signals S_{T}. The receiver device 5, 15 stops the first running time once the first time counted in the receiver device matches the first final time in the received data signals S_{T}. Finally, it stops the second running time once the second time counted in the receiver device matches a second final time in the received data signals S_{T}.

In the case of a sports competition, such as rowing, receiver device 5, 15 receives data signals from transmitter device 2 for refreshing, after a determined temporal lag Δt, a running time for the sports competition in progress for several competitors who started at the same time. Intermediate distances may be calculated for each competitor and displayed on a display screen of the receiver device upon reception of one or several intermediate times or distances and at least one final time in the received data signals S_{T}.

FIG. 2 shows a simplified view of an embodiment of a receiver device 17 capable of refreshing at least one running time for a sports competition in progress. This receiver device is preferably a mobile telephone 17, which includes electronic circuits (not shown) arranged inside a case closed by display screen glass 27. One or several buttons or touch sensitive keys 25 may be provided at the periphery of display screen 27 or on said display screen.

A first running time 29 for a first competitor may be displayed on the display screen with all of the information 28 associated therewith, the type of race, and a chronological classification 30 of certain preceding competitors. On the display screen, a second running time (not shown) for a second competitor, who started after the first competitor, may be displayed underneath the first running time 29. Two different running times 29 may be displayed. The display screen can also display the first and second starting times, first and second intermediate times, and the first and second finish times for two competitors in succession or at the same time.

Reference may be made to FIG. 3 to show clearly the reception times of all the time signals for two racing competitors in the same receiver device, such as a mobile telephone, as described hereinbefore. FIG. 3 thus shows a time graph of time data signals transmitted by a transmitter device relating to two racing competitors with a temporal lag between the two, and received by a receiver device according to the invention.

The transmitter device first of all transmits a first starting time t_{d1} for a first competitor. This first starting time is received by the receiver device after a previously calculated transmission time Tn. The receiver device starts refreshing the first running time after a determined temporal lag Δt time t_{Rd1}. After this first running time, the transmitter device transmits a second starting time t_{d2} for a second competitor. This second starting time is received by the receiver device after a transmission time Tn which may vary from one transmission to another. The receiver device starts refreshing the second running time after a determined temporal lag Δt time t_{Rd2}.

While the first and second competitors are racing, the transmitter device may transmit an intermediate time for each competitor. A first intermediate time at instant tᵢ₁ is transmitted by the transmitter device and received after a transmission time Tn by the receiver device. According to the refreshed first running time shifted by Δt in the receiver device, the first intermediate time is displayed at time t_{Ri1} once the time counted in the receiver device matches the first intermediate time received in the data signals. The same is true for a second intermediate time at instant tᵢ₂ transmitted by the transmitter device for the second competitor. The second intermediate time is displayed at time t_{Ri2} once the time counted in the receiver device matches the second intermediate time received in the data signals.

When the first and second competitors have finished racing, the transmitter device transmits a final time for each competitor. A first final time at instant tₐ₁ is transmitted by the transmitter device and received after a transmission time Tn by the receiver device. With the refreshed first running time shifted by Δt in the receiver device, the first final time is displayed at time t_{Ra1} once the time counted in the receiver device matches the final time received in the data signals. A second final time at instant tₐ₂ is transmitted by the transmitter device and received after a transmission time Tn by the receiver device. The second final time is displayed at time t_{Ra2} once the time counted in the receiver device matches the second final time received in the data signals.

Of course, the transmitter device may also transmit information to the receiver device if the competitor has not finished the race. This enables the receiver device to delete time information for this competitor.

From the description that has just been given, those skilled in the art can devise several variants of the method for refreshing a sports competition running time in a receiver device and an apparatus for implementing the same without departing from the scope of the invention defined by the claims. The time data signal transmitter device may also be located at a different place from the venue where the sports competition is taking place.

What is claimed is:

1. A method for refreshing at least one running time for a sports competition in progress in at least one receiver device on the basis of data signals transmitted by a transmitter device, wherein said method includes the steps of:
transmitting data signals from the transmitter device as the sports competition is taking place,
receiving data signals in at least one receiver device, and
in the receiver device, refreshing the running time of the sports competition in progress after a determined temporal lag in said receiver device, following the indication of a starting time in the received data signals, and
stopping the running time in the receiver device, once the time counted in the receiver device matches the final time in the received data signals.

2. The method according to claim 1, wherein the receiver device refreshes at least one running time for the sports competition in progress with a determined temporal lag following the indication of a starting time in the received data signals, wherein the receiver device supplies data for one or several intermediate times during the refreshment of the running time each time that the time counted in the receiver device matches one or several successive intermediate times in the received data signals, and wherein the receiver device stops the running time once the time counted in the receiver device matches the final time in the received data signals.

3. The method according to claim 1, wherein the receiver device includes a display screen, wherein the receiver device displays, on the display screen, with a determined temporal lag, the starting time of the running time refreshed in the device, the intermediate time or times and the final time.

4. The method according to claim 1, wherein the data signals supplied by the transmitter device are transmitted via a communication network of the Internet or UMTS type to at least one receiver device remote from the sports competition venue for refreshing the running time of the sports competition in progress.

5. The method according to claim 1, wherein, prior to refreshing a running time in the receiver device, an initial data signal transmission phase is performed between the transmitter device and the receiver device so as to determine a data transmission time between the transmitter device and the receiver device and to set a determined temporal lag in the receiver device, which is greater than the transmission time.

6. The method according to claim 1, wherein the receiver device refreshes a first running time of the sports competition in progress for a first competitor, after a determined temporal lag in said receiver device, following the indication of a first starting time for the first competitor in the received data signals, and wherein the receiver device refreshes a second running time of the sports competition in progress for a second competitor with a determined temporal lag following the indication of a second starting time for the second competitor in the received data signals prior to or after reception by the receiver device of a first final time for the first competitor in the received data signals, wherein the receiver device stops the first running time once the first time counted in the receiver device matches the first final time in the received data signals, and wherein the receiver device stops the second running time once the second time counted in the receiver device matches a second final time in the received data signals.

7. The method according to claim 6, wherein the first and second starting times, first and second intermediate times and the first and second final times of the two competitors are displayed at the same time on a display screen of the receiver device during the period of time when both competitors are racing.

8. The method according to claim 7, wherein the display screen of the receiver device displays a classification of the sports competition in progress with a determined temporal lag, at the same time as the first and/or second running time of the first and/or second competitors who are racing, refreshed in the receiver device.

9. The method according to claim 1, wherein the transmitter device transmits data signals to at least one receiver device for refreshing, after a determined temporal lag, a running time of the sports competition in progress for several competitors who started at the same time, and wherein intermediate distances are calculated for each competitor and displayed on a display screen of the receiver device upon reception of one or several intermediate times and at least one final time in the received data signals.

10. A data transmission apparatus for implementing the method for refreshing at least one running time for a sports competition in progress in at least one receiver device according to claim 1, wherein the apparatus includes a transmitter device, which contains a timing circuit for measuring the time of a sports competition, the transmitter device transmitting data signals relating to the starting time of the sports competition and data signals relating to the final time of the sports competition, and at least one receiver device for receiving the data signals from the transmitter device so as to refresh at least one time of the sports competition in progress after a determined temporal lag in the receiver device so as to refresh the running time continuously and without any jerkiness.

11. The apparatus according to claim 10, wherein the receiver device is connected to the transmitter device via an electric cable, and the transmitter device is at the sports competition venue.

12. The apparatus according to claim 10, wherein the receiver device is connected to the transmitter device via a communication network of the Internet or UMTS type.

13. The apparatus according to claim 12, wherein several receiver devices remote from the venue where the sports competition is taking place are mobile telephones for individually refreshing and displaying a running time after a temporal lag determined respectively for each mobile telephone following reception of a starting time in the received data signals.

14. The apparatus according to claim 12, wherein at least one receiver device remote from the venue where the sports competition is taking place is a computer station for refreshing and displaying a running time after a determined temporal lag in the computer station following reception of a starting time in the received data signals.

15. The apparatus according to claim 10, wherein the receiver device includes a display screen capable of displaying a first refreshed running time for a first competitor, a second refreshed running time for a second competitor and part of a chronological classification of several competitors who have finished the race.
